(19) United States
(12) Patent Application Publication
(10) Pub. No.: US 2009/0056590 A1
(43) Pub. Date: Mar. 5, 2009

(54) HIGH-HARDNESS CARBON COATING

(75) Inventors: Shinya OKAMOTO, Hitachi (JP); Shoichi NAKASHIMA, Hitachi (JP); Noboru BABA, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/193,873

(22) Filed: Aug. 19, 2008

(30) Foreign Application Priority Data
Aug. 27, 2007 (JP) 2007-219194

(51) Int. Cl. C09D 1/00

(52) U.S. Cl. 106/286.1

(57) ABSTRACT

The present invention provides a high-hardness carbon coating comprising Mo elements of 2.7 to 7.7 at %, S elements of 1.3 to 4.6 at % and O elements of 7.0 to 9.5 at %, and having a low friction and an excellent abrasion resistance under evacuated conditions.

### CLAIM OF PRIORITY

The present application claims priority from Japanese patent application serial No. 2007-219194, filed on Aug. 27, 2007, the content of which is hereby incorporated by reference into this application.

### BACKGROUND OF THE INVENTION

1. Field of the Invention

The present invention relates to a high-hardness carbon coating with low friction and excellent abrasion resistance and a slide member having the same.

2. Description of Related Art

A high-hardness carbon coating generally has high hardness and a flat and smooth surface. It has excellent abrasion resistance in atmosphere and, because of the solid lubrication properties, it has a low friction coefficient and superior low friction properties.

In atmosphere and in an unlubricated condition, the friction coefficient of a steel surface with typical flatness and smoothness is 0.5 or more and the friction coefficients of the surfaces of a Ni—P plating, Cr plating, TiN coating and CrN coating, etc. which are conventional surface treatment materials are about 0.4. On the other hand, the friction coefficient of the surface of a high-hardness carbon coating is about 0.12.

Currently, utilizing such excellent properties, there have been attempts to apply these to a cutting instrument including a drill blade, a manufacturing tool including a gliding tool, etc. and a die for deformation process, a slide member, etc. including a valve cock and a capstan roller which are used in atmosphere and in unlubricated conditions.

Sliding in a lubricated condition has become mainstream now in machine components including internal combustion where a decrease in the mechanical loss is desired to the greatest extent practicable from the point of view of energy consumption and the environment.

However, if low friction can be achieved by applying a high-hardness carbon coating which has solid lubrication properties in atmosphere and in an unlubricated condition, it is preferable because of a decrease in loading to the mechanical components even when the lubrication oil is discharged at the slide member and, since a decrease in the lubrication oil will be possible in the future, it is preferable for consideration of the global environment.

Even in analytical instruments having a sliding system for conveyance under evacuated conditions, such as a surface analysis instrument for semi-conductor, a decrease in the mechanical loss is desired. In such a slide member, because of contamination control under evacuated conditions, it is not possible to use a lubrication oil which may generate gases and steam at the slide member, so that molybdenum disulfide mainly has been used. Molybdenum disulfide is a solid lubrication material where gases are not generated even in evacuated conditions and low friction can be achieved. Generally, it is said that the friction coefficient of molybdenum disulfide is 0.05 in evacuated conditions and 0.1 to 0.2 in atmosphere.

On the other hand, it is said that the friction coefficient of the high-hardness carbon coating is 0.4 in evacuated conditions and 0.1 to 0.2 in atmosphere. Although the friction coefficients of molybdenum disulfide and the high-hardness carbon coating have no significant difference in atmosphere, the friction coefficient of molybdenum disulfide is overwhelmingly lower in evacuated condition.

A slide member having a diamond-like-carbon layer is described in Document 1 (Japanese Patent Laid-open No. 2004-115826).

[Document 1] Japanese Patent Laid-open No. 2004-115826

### SUMMARY OF THE INVENTION

A high-hardness carbon coating comprises Mo elements of 2.7 to 7.7 at %, S elements of 1.3 to 4.6 at % and O elements of 7.0 to 9.5 at %. According to the present invention, the carbon coating having a low friction and an excellent abrasion resistance under evacuated conditions can be provided.

### BRIEF DESCRIPTION OF THE REFERRED EMBODIMENTS

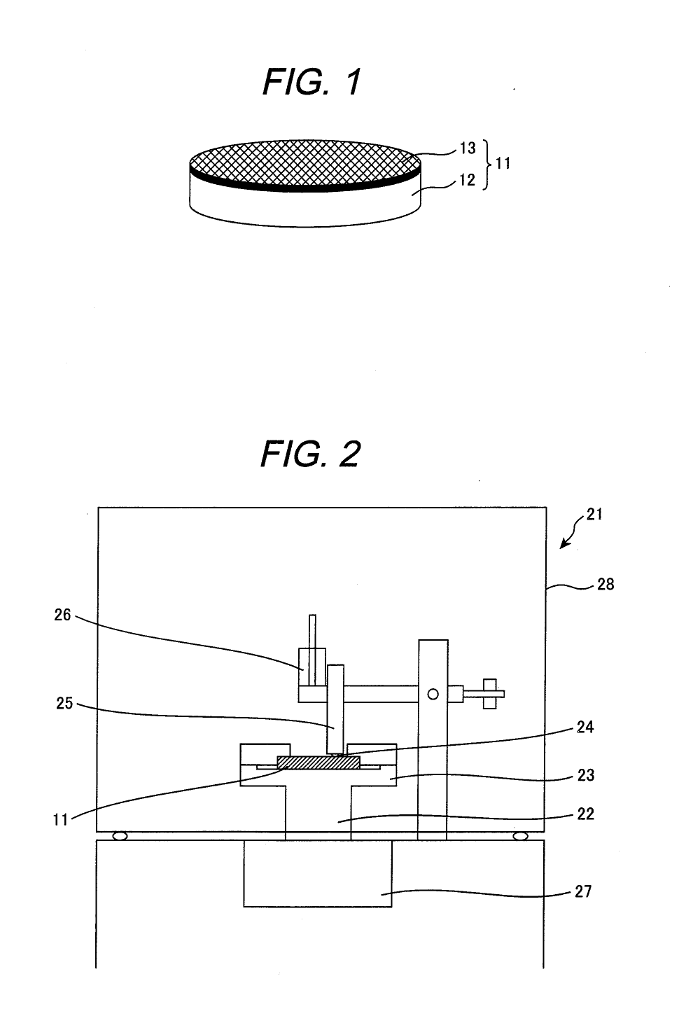

FIG. 1 is a perspective view illustrating a test piece where a high-hardness carbon coating is formed over a disk substrate.

FIG. 2 is a cross-sectional view illustrating a friction tester used for an evaluation of an embodiment according to the present invention.

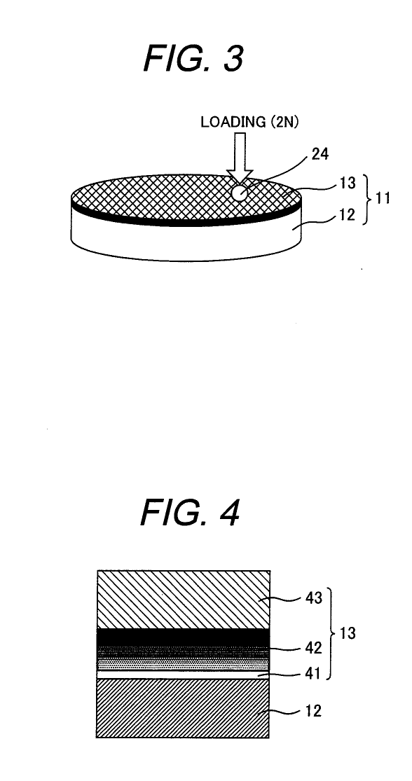

FIG. 3 is a perspective view illustrating a friction tester (test piece-ball sliding area) used for an evaluation of an embodiment according to the present invention.

FIG. 4 is a cross-sectional view illustrating a structure of a substrate and a high-hardness carbon coating.

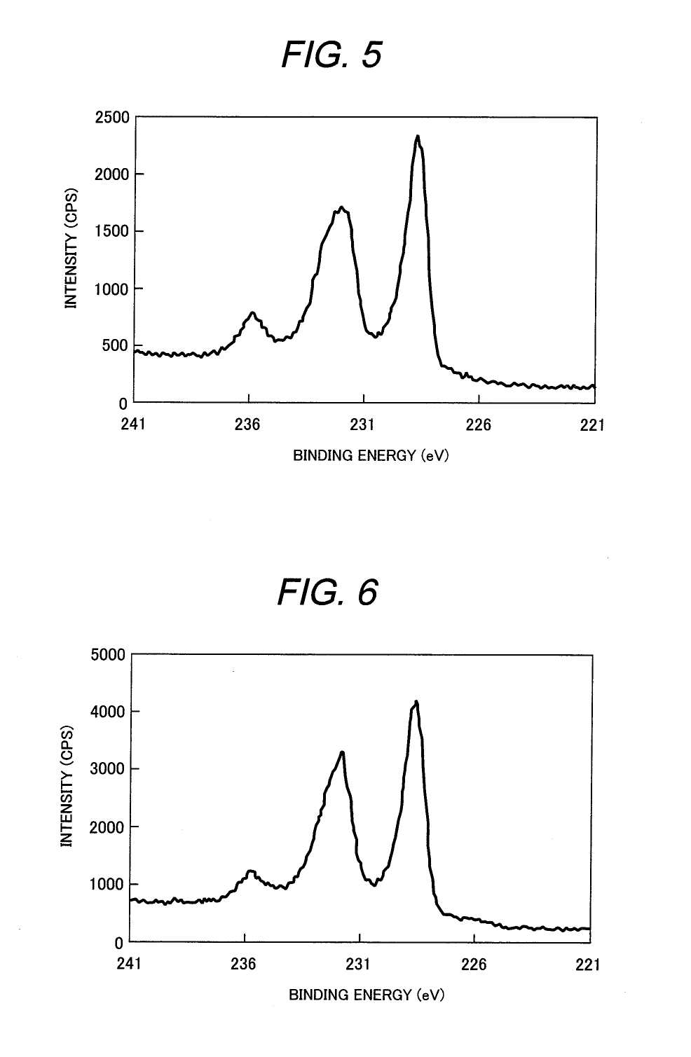

FIG. 5 is an XPS spectrum (Mo3d) of a surface layer of a high-hardness carbon coating in a first embodiment.

FIG. 6 is an XPS spectrum (Mo3d) of a surface layer of a high-hardness carbon coating in a second embodiment.

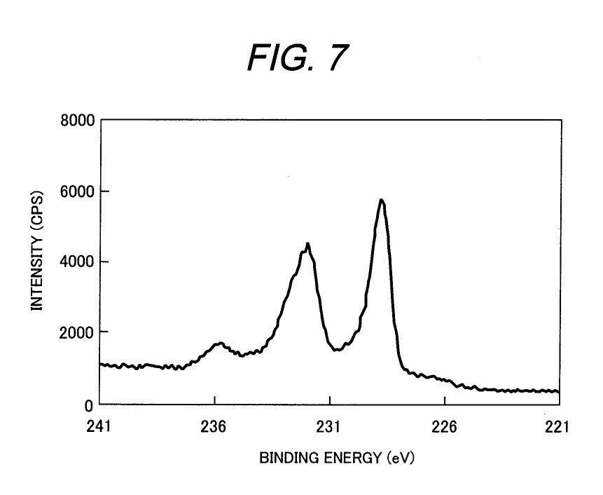

FIG. 7 is an XPS spectrum (Mo3d) of a surface layer of a high-hardness carbon coating in a first comparative sample.

### DETAILED DESCRIPTION OF THE PREFERRED EMBODIMENTS

When molybdenum disulfide is conventionally used as a solid lubrication material in the slide member under evacuated conditions, the adherence force with the substrate is low and abrasion powder is generated from the lubrication material, so that there has been a problem that evacuated conditions are contaminated.

On the other hand, the high-hardness carbon coating has a higher adherence force than that of molybdenum disulfide. However, the high-hardness carbon coating is heavily abraded under evacuated conditions, so that there has been a problem that evacuated conditions are contaminated by generating abrasion powder as powder dust.

Moreover, S elements are not included in the conventional high-hardness carbon coating, so that there has been a problem that it does not become a solid lubrication material having low friction properties and excellent abrasion resistance under evacuated conditions.

It is an objective of the present invention to provide a solid lubrication material (specifically, a high-hardness carbon coating) which has low friction properties and excellent abrasion resistance under evacuated conditions.

A high-hardness carbon coating of an embodiment of the present invention contains Mo elements of 2.7 to 7.7 at %, S elements of 1.3 to 4.6 at % and O elements of 7.0 to 9.5 at %. Preferably, it contains Mo elements of 2.7 to 6.0 at %, S elements of 1.3 to 2.8 at % and O elements of 7.0 to 8.8 at %.

Herein, there is a case where the high-hardness carbon coating is generally called a diamond-like-carbon film and the coating like this is formed over a substrate. Herein, one including a high-hardness carbon coating formed over a substrate is called a member. Specifically, the member where the sliding property is taken into consideration is called a slide member.

It is preferable that Mo elements, S elements and O elements be contained in the surface layer and the internal layer of the high-hardness carbon coating.

Moreover, it is preferable that the hardness of the high-hardness carbon coating be 20 GPa or more. It is more preferable that the hardness of the high-hardness carbon coating be 23 GPa or more.

It is preferable that the thickness of the high-hardness carbon coating be 0.2 to 0.3 μm.

It is preferable that sp² combined carbon coexist with sp³ combined carbon in the surface layer of the high-hardness carbon coating.

It is preferable that at least one element selected from the group containing V, Cr, Fe, Co, Ni, Zr, Nb, Mo, Ta, W, Ir and Pt be contained in the substrate.

A gradient layer containing Cr elements and C elements is provided over the substrate and a high-hardness carbon coating (diamond-like-carbon layer) is provided over the gradient layer. The content of Cr elements contained in the gradient layer gradually decreases from the substrate to the high-hardness carbon coating and the content of C elements contained in the gradient layer gradually increases from the substrate to the high-hardness carbon coating.

A Cr interlayer may be provided between the substrate and the gradient layer. Moreover, it is preferable that the gradient layer be metallic chromium containing carbon elements or a chromium carbide.

Moreover, a method for manufacturing a slide member of an embodiment of the present invention comprises the step for forming a high-hardness carbon coating composed of a diamond-like-carbon film, which contains Mo elements of 2.7 to 7.7 at %, S elements of 1.3 to 4.6 at % and O elements of 7.0 to 9.5 at %, over the substrate by using a sputtering method or an ion plating method.

According to the present invention, a high-hardness carbon coating can be provided, which has a low friction and an excellent abrasion resistance under evacuated conditions.

Hereinafter, preferred embodiments of the present invention are described. However, it is to be understood that the invention is not intended to be limited to the specific embodiments.

A high-hardness carbon coating described in the embodiment is one which can apply to a slide member such as a machine component to be used under evacuated conditions. The adherence properties, the hardness and the frictional properties of a high-hardness carbon coating 13 were evaluated using a test pieces 11 where the high-hardness carbon coating 13 was formed over a disk substrate 12 with a diameter of 32 mm and a thickness of 5.2 mm as shown in FIG. 1.

The test pieces 11 have the specifications (the contents of Mo elements, S elements and O elements, and the film thickness) shown in Table 1 and one where the high-hardness carbon coating 13 was formed over the substrate 12. The high-hardness carbon coating 13 is a diamond-like-carbon (DLC) layer over the substrate 12 using an unbalanced magnetron sputtering method.

In the unbalanced magnetron sputtering method, the balance of the magnetic poles arranged at the back face of the target is intentionally shifted between the center of the target and the fringing part thereof and it is made to be in a nonequilibrium state, thereby a part of the lines of magnetism from the magnetic pole at the fringing part of the target can be extended to the substrate.

It is easy for plasma centralized in the vicinity of the target to diffuse to the neighborhood of the substrate along the lines of magnetism. Therefore, the ion content irradiated to the substrate 12 during the formation of the coating 13 can be increased. As a result, it is a deposition method for forming a dense coating 13 over the substrate 12.

After forming the coating 13, the concentrations of Mo elements, S elements and O elements contained in the surface of the coating 13 were quantitatively measured by using X-ray photoelectron spectroscopy (XPS).

By the indentation of the Rockwell diamond indenter into the coating 13, an evaluation of adherence properties the coating was carried out by checking the presence or absence of abrasion. Moreover, an evaluation of hardness of the coating 13 was performed on the surface of the coating 13 by using a nano-indentation method (ISO14577), and an evaluation of the friction coefficient and the abrasion resistance of the coating 13 were performed by the rubbing test under evacuated condition.

In the evaluation of adherence properties by the indentation test using a Rockwell diamond indenter, a Rockwell diamond indenter having a head diameter of 200 μm is indented with a test force of 1471 N (150 kgf), and the state of cracking and abrasion of the coating 13 in the vicinity of the trace made by this indention was observed by using an optical microscope. The evaluation using the nano-indentation method (ISO14577) was carried out by using the condition where a Berkovich indenter having a ridge angle of 115 degrees was indented into the surface of the coating 13 up to a maximum loading of 3 mN over a period of 10 seconds and held for one second at the maximum loading, and then it was removed over a period of 10 seconds.

According to these evaluations, the hardness was calculated. The rubbing test of the coating 13 under evacuated conditions was performed by using a friction tester 21 (ball-on-disk type) shown in FIG. 2. The friction coefficient was measured by using this friction tester 21 and the index of the abrasion resistance was determined by measuring the depth of the slide trace formed on the surface of the coating 13 after the friction test.

As for the friction tester 21, a work table 23 fixed to a rotation shaft 22 is arranged. The test piece 11 is placed over the work table 23 and a metallic ball 24 with a diameter of 6 mm (high carbon chromium bearing steel ball) is arranged over the upper side of this test piece 11 so as to be the other material of the test piece 11.

The metal used for the metallic ball 24 is intended not to be limited to the high carbon chromium bearing steels, and steel used for a bearing may be acceptable. The metallic ball 24 is fixed to the holder 25 so as not to be rotated.

Moreover, the loading which indents the metallic ball 24 into the test piece 11 can be controlled by the weight. 2 N of loading was used in all tests. Then, the rotation shaft 22 was connected to the motor 27 and rotated to the metallic ball 24 with a relative sliding velocity 31 mm/sec; the torque was measured corresponding to the frictional force generated between the metallic ball 24 and the test piece 11; and the friction coefficient was calculated.

As shown in FIG. 3, one metallic ball 24 was provided at a radial position of 6 mm from the center. The sliding test distance is assumed to be 100 m for all test pieces and the average friction coefficient of each test piece was determined from the friction coefficient from the sliding test distance of 90 m to 100 m. This friction test was carried out inside of a chamber 28 where atmosphere control was enabled. After the pressure in the chamber 28 was evacuated to be 0.1 Pa, evacuation was stopped and the test was performed while maintaining evacuated conditions. Moreover, after completing the friction test, the abrasion condition of the coating 13 was confirmed by measuring the depth of the sliding track of the test piece 11.

### First Embodiment

Carburizing was carried out to make the surface hardness of the disk substrate 12 composed of a metal alloy (chromium molybdenum steel) containing Fe, Cr and Mo to be a Rockwell hardness scale C (HRC) value of 58 or more and dressing was carried out to achieve a surface roughness (Ra) of 0.1 μm or less.

After that, the coating 13 was formed by using the unbalanced magnetron sputtering method during introduction of an inert gas and a hydrocarbon gas. As shown in FIG. 4, the coating 13 has a Cr interlayer 41, a surface layer 43, and a gradient layer 42 between the Cr interlayer 41 and the surface layer 43. When the surface layer 43 was formed, a power of 3.0 kW and 0.05 kW were input to a C target and a MoS₂ target, respectively.

After formation of the coating 13, the concentration of each Mo, S, O and C elements was putatively measured by using XPS analysis. The sum of the concentration of all elements of Mo, S, O and C was assumed to be 100 at %. As a result, it was confirmed that Mo: 2.7 at %, S: 1.3 at %, O: 7.0 at % and C: 88.9 at %. Herein, a unit of at % is based on numbers of atoms of the elements.

In addition, wave analysis was done by performing the peak separation on the spectrum obtained by the XPS analysis as shown in FIG. 5, thereby it was confirmed that the coating 13 contained a sulfide containing MoS₂ and MoS₃ and an oxide containing MoO₂, Mo₂O₅ and MoO₃.

The film thickness of the surface layer 43 of the coating 13 was 0.24 μm.

Moreover, as a result of the evaluation of the adherence properties by the indentation of the Rockwell diamond indenter into the coating 13 after the deposition, breaking-away of the coating in the vicinity of the trace was not observed, so that the adherence properties between the substrate 13 and the coating 12 was excellent.

Moreover, the hardness of surface layer 43 of the coating 13 was 26.7 GPa.

As the result of the rubbing test between the coating 13 and the metallic ball 24 under evacuated conditions, the average friction coefficient was 0.06. Moreover, after the rubbing test, the depth of the sliding track was 0.1 μm or less.

When the coating 13 of this embodiment was slid under evacuated conditions, the friction coefficient was 0.2 or less and about 85% of the friction coefficient can be reduced compared to a typical high-hardness carbon coating under evacuated conditions, so that it was understood that the low friction properties of the coating 13 could be fully utilized under evacuated conditions. Moreover, the depth of the sliding track after the rubbing test is smaller than the 0.24 μm film thickness of the surface layer 43 of the coating 13, so that it can be said that the abrasion resistance is excellent. Furthermore, the hardness of the coating 13 of this embodiment is about two times harder than the hardness of the untreated disk substrate 12 (13.7 GPa), so that it also can be said that the abrasion resistance is excellent.

When the coating 13 of the first embodiment is applied to a solid lubrication material of the slide member which is operated under evacuated conditions, loading on the machine equipment related to the slide member can be decreased, resulting in machine equipment having high energy efficacy being provided.

Moreover, since it has excellent abrasion resistance and since dusting under evacuated conditions caused by abrasion powder can be suppressed, contamination inside the analysis instruments having evacuated conditions can be avoided, resulting in equipment with high reliability being provided.

The coating 13 of the first embodiment is a high-hardness carbon coating where sp² combined carbon which is a carbon bonding represented by graphite coexists with sp³ combined carbon which is a carbon bonding represented by diamond. As a result, the coating 13 having both abrasion resistance and low friction properties can be provided. The high-hardness carbon coating is a film containing amorphous like carbon or hydrogenated carbon, and it is called amorphous carbon or hydrogenated amorphous carbon (a-C:H) and diamond-like-carbon (DLC), etc.

A plasma CVD method for deposition by plasma decomposition of a hydrocarbon gas, a gas-phase synthesis method such as an ion beam deposition, etc. using carbon and hydrocarbon ions, an ion plating method for deposition by evaporating graphite, etc. using arc-discharge, and a sputtering method for deposition by sputtering a target in an inert gas atmosphere are used for the formation thereof.

The coating 13 formed by using the first embodiment has low friction properties and abrasion resistance under evacuated conditions and can be applied to a slide member. As a result, a slide member can be provided in which dusting caused by abrasion powder is small under evacuated conditions.

In the first embodiment, the substrate 12 on which the coating 13 is formed contains at least one element selected from the group containing V, Cr, Fe, Co, Ni, Zr, Nb, Mo, Ta, W, Ir and Pt. However, the temperature increases during formation of the coating 13, so that a high-melting point metal (specifically, Fe, Co, Ni) is preferable for preventing deterioration.

Furthermore, the Cr interlayer 41 is formed during the formation of the high-hardness carbon coating. In order to obtain a high-hardness carbon coating having excellent abrasion resistance and low friction under evacuated conditions, it is necessary to improve the adherence properties between layers constituting the coating 13 and to decrease the internal stress inside of the layer.

In order to improve the adherence properties between the substrate 12 and the Cr interlayer 41, it is preferable that the substrate 12 contains Cr. Moreover, in order to decrease the internal stress inside the layer in the gradient layer 42 formed between the Cr interlayer 41 and the surface layer 43, it is preferable that the concentration of Cr elements continuously decrease and the concentration of C elements continuously increase from the Cr interlayer 41 side to the surface layer 43.

When it is thought that the gradient layer 42 is a layered structure in which each layer has different region of composition (the amounts of Cr and C contained therein are different), the film thickness of one layer is preferably 15 nm or less.

Moreover, when the Cr carbide which is a material constituting the gradient layer 42 is shown as CrₓC_{y}, the composition gradually changes from the Cr interlayer 41 side to the surface layer 43 side by gradually changing the ratio of x and y. As a result, the coating properties of the gradient layer 42 do not change suddenly.

Moreover, when the film thickness of the surface layer 43 is less than 0.2 μm, it is not preferable because the surface layer 43 is easily worn by sliding.

On the other hand, when the film thickness of the surface layer 43 is thicker than 0.3 μm, specifically when it is a high-hardness carbon coating containing MoS₂, the hardness of the surface layer 43 is decreased and the depth of abrasion caused by sliding becomes greater than the film thickness of the surface layer 43. As a result, it is not preferable because the abrasion powder contaminates evacuated conditions.

The coating 13 is formed by using a sputtering method, a plasma CVD method and an ion plating method, etc. The coating 13 is preferably formed by using a sputtering method or an ion plating method.

Moreover, the coating 13 is one having a surface layer 43 which contains Mo elements, S elements and O elements. The contents of Mo elements, S elements and O elements are 2.7 to 7.7 at %, 1.3 to 4.6 at % and 7.0 to 9.5 at %, respectively. Preferably, Mo elements are 2.7 to 6.0 at %, S elements 1.3 to 2.8 at % and O elements 7.0 to 8.8 at %. Mo elements exist as a mixture of MoS₂, MoS₃, MoO₂, MoO₃ and Mo₂O₅.

As a result of these element compositions, a high-hardness carbon coating can be provided in which both low friction properties and abrasion resistance are provided under evacuated conditions. The coating 13 formed in the first embodiment has abrasion resistance and low friction properties under evacuated conditions, resulting in its being applied to slide members.

As a result, a slide member which can decrease the loading under evacuated conditions is provided and the reliability of not contaminating the evacuated conditions can be maintained by the low dusting characteristics due to the abrasion resistance.

The first embodiment is based on the phenomenon that it is difficult for the coating 13 to break away from the substrate 12 because the internal stress of the coating 13 is decreased by the existence of Mo elements, S elements and O elements.

When the content of Mo elements, S elements and O elements in the surface layer 43 is less than 2.7 at %, less than 1.3 at % and less than 7.0 at %, respectively, the amount of material working as a medium for sliding between the surface layer 43 of the coating 13 and the other material under evacuated conditions becomes small or absent, low friction properties and abrasion resistance can not be expected.

On the other hand, when the content of Mo elements, S elements and O elements in the surface layer 43 and the internal thereof is greater than 7.7 at %, 4.6 at % and 9.5 at %, respectively, the surface hardness of the surface layer 43 is less than 20 GPa, resulting in the abrasion resistance being decreased and abrasion powder being generated easily.

When it is formed by using a sputtering method or an ion plating method, MoS₂ and Mo oxides can be added to the coating 13 by using a MoS₂ target.

On the other hand, in a plasma CVD method, Mo elements can be added to the coating 13 by introducing an organic molybdenum compound represented by molybdenum dithiophosphate, etc into the chamber as a vapor.

Moreover, the target application of the first embodiment is, for instance, a carrier slide mechanism in a surface analysis instrument for semi-conductors which requires low friction properties, abrasion resistance and low dusting characteristics of the slide member under evacuated conditions.

The surface layer 43 of the coating 13 and the inside thereof contain Mo elements of 2.7 to 7.7 at %, S elements of 1.3 to 4.6 at % and O elements of 7.0 to 9.5 at %, resulting in the ability to realize low friction properties, abrasion resistance and low dusting characteristics under evacuated conditions.

It is preferable that the hardness of the surface layer 43 be 20 GPa or more and the layer thickness thereof be 0.2 to 0.3 Mm.

### Second Embodiment

Carburizing was carried out to make the surface hardness of the disk substrate 12 composed of a chromium molybdenum steel be an HRC of 58 or more and dressing was carried out to achieve an Ra of 0.1 μm or less. After that, the coating 13 was formed by using the unbalanced magnetron sputtering method during introduction of an inert gas and a hydrocarbon gas. As shown in FIG. 4, the coating 13 has a Cr interlayer 41, a surface layer 43, and a gradient layer 42 between the Cr interlayer 41 and the surface layer 43. When the surface layer 43 was formed, a power of 3.0 kW and 0.1 kW were input to the C target and MoS₂ target, respectively.

After formation of the coating 13, the concentration of each Mo, S, O and C element was putatively measured by using XPS analysis.

The sum of the concentrations of all elements of Mo, S, O and C was assumed to be 100 at %.

As a result, it was confirmed that Mo: 6.0 at %, S: 2.8 at %, O: 8.8 at % and C: 82.4 at %.

In addition, wave analysis was done by performing the peak separation on the spectrum obtained by the XPS analysis as shown in FIG. 6, thereby it was confirmed that the coating 13 contained a sulfide containing MoS₂ and MoS₃ and an oxide containing MoO₂, Mo₂O₅ and MoO₃.

The film thickness of the surface layer 43 of the coating 13 was 0.29 μm.

Moreover, as a result of the evaluation of the adherence properties by the indentation of the Rockwell diamond indenter into the coating 13, breaking-away of the coating in the vicinity of the trace was not observed, so that the adherence properties between the substrate 12 and the coating 13 was excellent.

Moreover, the hardness of the coating 13 was 23.1 GPa.

As the result of the friction test between the coating 13 and the metallic ball 24 under evacuated conditions, the average friction coefficient was 0.12. In addition, the depth of the sliding track was 0.18 μm after the rubbing test.

When the coating 13 of this embodiment was slid under evacuated conditions, the friction coefficient was 0.2 or less and about 70% of the friction coefficient can be reduced compared to a typical high-hardness carbon coating under evacuated conditions, so that it was understood that the low friction property of the coating 13 could be fully utilized under evacuation condition.

Moreover, the depth of the sliding track after the rubbing test is smaller than the film thickness of 0.29 μm of the surface layer 43 of the coating 13, so that it can be said that the abrasion resistance is excellent.

Furthermore, the hardness of the coating 13 of this embodiment is about 1.7 times harder than the hardness of the untreated disk substrate 12 (13.7 GPa), so that it can also be said that the abrasion resistance is excellent.

When the coating 13 of the second embodiment is applied to a solid lubrication material of the slide member which is operated under the evacuated condition, loading on the machine equipment related to the slide member can be decreased, resulting in machine equipment having high energy efficacy being provided.

Moreover, since it has excellent abrasion resistance and since dusting under evacuated conditions caused by abrasion powder can be suppressed, contamination inside the analysis instrument having evacuated conditions can be avoided, resulting in equipment with high reliability being provided.

### (First Comparative Sample)

Carburizing was carried out to make the surface hardness of the disk substrate 12 composed of a chromium molybdenum steel to be an HRC value of 58 or more and dressing was carried out to achieve an Ra of 0.1 μm or less. After that, the coating 13 was formed by using the unbalanced magnetron sputtering method during introduction of an inert gas and a hydrocarbon gas.

As shown in FIG. 4, the coating 13 has a Cr interlayer 41, a surface layer 43, and a gradient layer 42 between the Cr interlayer 41 and the surface layer 43. When the surface layer 43 was formed, a power of 3.0 kW and 0.2 kW were input to the C target and the MoS₂ target, respectively.

After formation of the coating 13, the concentration of each Mo, S, O and C element was putatively measured by using XPS analysis. The sum of the concentration of all elements of Mo, S, O and C was assumed to be 100 at %. As a result, it was confirmed that Mo: 9.4 at %, S: 6.4 at %, O: 10.0 at % and C: 74.2 at %.

In addition, wave analysis was done by performing the peak separation on the spectrum obtained by the XPS analysis as shown in FIG. 7, thereby it was confirmed that the coating contained a sulfide containing MoS₂ and MoS₃ and an oxide containing MoO₂, Mo₂O₅ and MoO₃.

The film thickness of the surface layer 43 of the coating 13 was 0.33 μm.

Moreover, as a result of the evaluation of the adherence properties by the indentation of the Rockwell diamond indenter into the coating 13, breaking-away of the coating in the vicinity of the trace was a tiny region, so that the adherence properties between the substrate 12 and the coating 13 was almost excellent. Moreover, the hardness of the coating 13 was 16.8 GPa.

As the result of the friction test between the coating 13 and the metallic ball 24 under evacuated conditions, the average friction coefficient was 0.09. In addition, the depth of the sliding track was 0.47 μm after the rubbing test.

When the coating 13 of this embodiment was slid under evacuated conditions, the friction coefficient was 0.2 or less and about 77% of the friction coefficient can be reduced compared to a typical high-hardness carbon coating under an evacuated condition, so that it was understood that the low friction property of the coating could be fully utilized under an evacuated condition.

However, the depth of the sliding track after the rubbing test is deeper than the film thickness of 0.33 μm of the surface layer 43 of the coating 13, so that the abrasion resistance becomes worse.

Furthermore, the hardness of the coating 13 of this comparative sample is only about 1.2 times harder than the hardness of the untreated disk substrate 12 (13.7 GPa), so that it can also be said that the abrasion resistance becomes worse.

When the coating 13 of the first comparative sample is applied to a solid lubrication material of the slide member which is operated under evacuated conditions, loading on the machine equipment related to the slide member can be decreased, resulting in machine equipment having high energy efficacy being provided.

However, since it has low abrasion resistance, and since dusting under evacuated conditions caused by abrasion powder can not be suppressed, contamination in the analysis instrument having evacuated conditions can not be avoided, resulting in equipment with high reliability not being provided.

### (Second Comparative Sample)

Carburizing was carried out to make the surface hardness of the disk substrate 12 composed of a chromium molybdenum steel to be an HRC value of 58 or more and dressing was carried out to achieve an Ra of 0.1 μm or less.

After that, the coating 13 was formed by using the unbalanced magnetron sputtering method during introduction of an inert gas and a hydrocarbon gas. As shown in FIG. 4, the coating 13 has a Cr interlayer 41, a surface layer 43, and a gradient layer 42 between the Cr interlayer 41 and the surface layer 43. When the surface layer 43 was formed, a power of 3.0 kW was input to the C target and no power was input to the MoS₂ target.

After formation of the coating 13, the concentration of each Mo, S, O and C element was putatively measured by using XPS analysis.

The sum of the concentration of all elements of Mo, S, O and C was assumed to be 100 at %. As a result, it was confirmed that Mo: 0.0 at %, S: 0.0 at %, O: 4.4 at % and C: 95.7 at %.

The film thickness of the surface layer 43 of the coating 13 was 0.16 μm.

Moreover, as a result of the evaluation of the adherence properties by the indentation of the Rockwell diamond indenter into the coating 13, breaking-away of the coating in the vicinity of the trace was not observed, so that the adherence properties between the substrate 12 and the coating 13 was excellent.

Moreover, the hardness of the coating 13 was 30.1 GPa.

As the results of the friction test of the coating 13 under the evacuated condition, the depth of the sliding track after the rubbing test was 1.6 μm.

When the coating 13 of this comparative sample was slid under evacuated conditions, the depth of the sliding track became deeper than the 0.16 μm film thickness of the coating 13. There exists no material to be a medium for sliding between the coating 13 and the other material under evacuated conditions, so that the abrasion resistance becomes worse.

When the coating 13 of the second comparative sample is applied to a solid lubrication material of the slide member which is operated under the evacuated condition, since it has low abrasion resistance and since dusting under the evacuated condition caused by abrasion powder can not be suppressed, contamination of the analysis instrument having evacuated conditions can not be avoided, resulting in equipment with high reliability not being provided.

TABLE 1

| | | | | Comparative | Comparative |
|---|---|---|---|---|---|
| | | Embodiment 1 | Embodiment 2 | embodiment 1 | embodiment 2 |
| Concentration | Mo | 2.7 | 6.0 | 9.4 | 0.0 |
| of element | S | 1.3 | 2.8 | 6.4 | 0.0 |
| (at %) | O | 7.0 | 8.8 | 10.0 | 4.4 |
| | C | 88.9 | 82.4 | 74.2 | 95.7 |

| | | | | |
|---|---|---|---|---|
| Adherence | No | No | Small | No |
| property | breaking-away | breaking-away | breaking-away | breaking-away |
| (Rockwell | | | | |
| indenter) | | | | |
| Hardness of | 26.7 | 23.1 | 16.8 | 30.1 |
| coating (GPa) | | | | |
| Film thickness of | 0.24 | 0.29 | 0.33 | 0.16 |
| surface layer (μm) | | | | |
| Depth of sliding | 0.1 or less | 0.18 | 0.47 | 1.6 |
| track (μm) | | | | |
| Average friction | 0.06 | 0.12 | 0.09 | — |
| coefficient | | | | |

The above-mentioned results are summarized in Table 1.

The present invention provides a high-hardness carbon coating having a low friction property and excellent abrasion resistance under an evacuated condition and, specifically, it is applicable to slide members in analysis instruments, such as analysis instrument for semi-conductors, used under evacuated conditions.

What is claimed is:

1. A high-hardness carbon coating comprising:
Mo elements of 2.7 to 7.7 at %, S elements of 1.3 to 4.6 at % and O elements of 7.0 to 9.5 at %.

2. The high-hardness carbon coating according to claim 1, wherein
said Mo elements, S elements and O elements are contained in a surface layer and an internal layer.

3. The high-hardness carbon coating according to claim 1, wherein
the hardness of said high-hardness carbon coating is 20 GPa or more.

4. The high-hardness carbon coating according to claim 1, wherein
the thickness of said high-hardness carbon coating is 0.2 to 0.3 μm.

5. The high-hardness carbon coating according to claim 1, which includes sp² combined carbon coexisting with sp³ combined carbon.

6. A member comprising the high-hardness carbon coating according to claim 1 is formed over a substrate.

7. A method of manufacturing a high-hardness carbon coating comprising:
a step of forming the high-hardness carbon coating including a diamond-like-carbon film, which contains Mo elements of 2.7 to 7.7 at %, S elements of 1.3 to 4.6 at % and O elements of 7.0 to 9.5 at %, over a substrate by using a sputtering method or an ion plating method.

8. A slide member comprising:
a high-hardness carbon coating containing Mo elements, S elements and O elements being formed over a substrate.

9. The slide member according to claim 8, wherein
the content of Mo elements in said high-hardness carbon coating is 2.7 to 7.7 at %, the content of S elements is 1.3 to 4.6 at % and the content of 0 elements is 7.7 to 9.5 at %.

10. The slide member according to claim 9, wherein
said high-hardness carbon coating is a high-hardness carbon coating which includes sp² combined carbon coexisting with sp³ combined carbon.

11. The slide member according to claim 9, wherein
said substrate contains at least one element selected from a group containing V, Cr, Fe, Co, Ni, Zr, Nb, Mo, Ta, W, Ir and Pt.

12. The slide member according to claim 9,
wherein a gradient layer containing Cr elements and C elements is formed over said substrate, and the high-hardness carbon coating is formed over said gradient layer,
wherein the content of Cr elements contained in said gradient layer gradually decreases from said substrate to said surface layer; and the content of C elements contained in said gradient layer increases from said substrate to said surface layer.

13. The slide member according to claim 9, wherein
a Cr interlayer is provided between said substrate and said gradient layer.

14. The slide member according to claim 9, wherein
said gradient layer is metallic chromium containing carbon elements or a chromium carbide.
